(19) United States
(12) Patent Application Publication
(10) Pub. No.: US 2026/0231262 A1
(43) Pub. Date: Aug. 6, 2026

(54) MANAGEMENT OF WIRELESS NETWORKS AND WIRED NETWORKS

(71) Applicant: Charter Communications Operating, LLC, St. Louis, MO (US)

(72) Inventors: Rajendra Prasad Kodaypak, Sammamish, WA (US); Ayham Z. Al-Banna, Irving, TX (US)

(21) Appl. No.: 19/460,722

(22) Filed: Jan. 27, 2026

Related U.S. Application Data
(60) Provisional application No. 63/753,060, filed on Feb. 3, 2025.

(51) Int. Cl. H04W 76/15; H04W 72/27; H04W 72/543

(52) U.S. Cl. CPC H04W 76/15; H04W 72/27; H04W 72/543

(57) ABSTRACT

A communication management resource receives first input associated with a first network configured to provide connectivity to a communication device requesting to establish a communication path to a second communication device through the first network. The communication management resource also receives second input associated with a second network supporting connectivity between pairs of the first network nodes. Based on the first input and the second input, the communication management resource manages operation of the first network and the second network to establish a communication path between the mobile communication device and the second communication device over a combination of the first network and the second network.

### RELATED APPLICATION

This application claims the benefit of earlier filed U.S. Patent Application Ser. No. 63/753,060 entitled “MANAGEMENT OF WIRELESS NETWORKS AND WIRED NETWORKS,” (Attorney Docket No. CHTR-2024-185P), filed on Feb. 3, 2025, the entire teachings of which are incorporated herein by this reference.

### BACKGROUND

Conventional wireless networks provide connectivity of mobile communication devices to the Internet via respective wireless access points or wireless base stations such as based on wireless protocols including WiFi™, LTE (Long Term Evolution), 4G, 5G, 6G, NR (New Radio), etc.

As an example, via SIM (Subscriber Identity Module) information, assume that a mobile communication device establishes a respective wireless communication link with a first wireless base station. The first wireless base station is typically coupled to a so-called midhaul that provides connectivity between the first wireless base station and a remote network such as the Internet. Via communications over the respective wireless communication link, and corresponding one or more networks including at least one midhaul, the mobile communication device is able to send data to and receive data from the Internet or communicate with a remotely located communication device.

A so-called midhaul is a segment in a 5G network's transport infrastructure that connects the Distributed Unit (DU) to the Centralized Unit (CU), sitting between the fronthaul (Radio Unit/DU) and the backhaul (CU/Core Network), handling data flow for high-speed, low-latency mobile services like advanced MIMO.

In general, broadband network technologies support the transmission of wide bandwidth data over a high-speed communication path such as including a wireless connection between a communication device and a wireless access point or wireless base station.

It is noted that next generation converged broadband networking technologies continue to evolve with advancements in multi-access standards including 3GPP, O-RAN Alliance, ITU-T, BBF, IEEE, DOCSIS, as well as semiconductor materials, chipsets, SOC, new spectrum band allocations, cloud computing, open standards interfaces, network and service APIs, native AI/ML designs, digital endpoints, networking and social media applications.

Every new generation of broadband technology provides multiple opportunities with useful features and capabilities that enhance the way end users and devices are able to connect with other entities. For example, while the 5G new radio (NR) wireless network roll outs and expands globally, the 6G wireless standards are taking shape to plan and develop early proof-of-concepts, technology trials to demonstrate advances in connectivity and digital transformation.

Today's 5G standalone deployments, as per 3GPP standards recommendations and definitions, are largely focused on leveraging the spectrum allocations in frequency range 1 (a.k.a., FR1) and frequency range 2 (a.k.a., FR2) spectrum bands. Due to the bandwidth limitations and restrictions in these bands, a new band in frequency range 3 (FR 3) is being proposed for 6G. Other higher frequency bands beyond FR 3 such as FR 4, FR5 and FR6 are also being investigated for 6G.

### BRIEF DESCRIPTION OF EXAMPLES

It is noted that the availability of FR3 band in addition to FR1 and FR2 bands provides an opportunity for mobile network operators (MNOs) and other global carriers/MVNOs to drive additional radio system bandwidth, data transfer capacity, geo-coverage, reliability and latency performance enhancements beyond 5G NR when designing, deploying and rolling out 6G networks delivering advanced mobility services. At the same time, it is desirable to effectively control use of spectrum resources in order to provide the next generation services evolution for a wide variety of digital endpoints (UE, PDA, UAVs, XR/AR/VR, RG, IoT devices, Sensors etc.) that will get connected with the converged broadband wireless networks to address industry specific needs. To deliver seamless broadband high-speed low-latency mobility connected services to consumers, enterprises and service providers, the HFC/PON transport technologies needs to evolve accordingly to support wireless traffic demands.

This disclosure includes implementation of one or more management operations of managing multiple networks (wireless networks, wired networks, etc.) to provide connectivity between a first communication device and a second communication device. For example, one specific implementation of a communication management resource as discussed herein includes a so-called converged broadband network management orchestration system (CBNMO or otherwise known as a centralized communication management resource) that orchestrates multi-access domain management systems with open standards APIs to deliver next generation services.

The centralized communication management resource such as so-called CBNMO as discussed herein can be dynamically configured to function as an integrated network management system across the multi-access, transport and core networking domains with cross-domain mapping and traffic correlators for targeted end-to-end application performance metrics and KPI/KCI evaluation. In addition, the CBNMO as discussed herein can be configured to orchestrate broadband access domain slice-specific management system with integrated slice-mapping functions and associated slice specific latency across each domain. Further, the CBNMO as discussed herein is capable of ingesting the latency APIs from each of the access, transport and core domain management systems at the slice level.

Using the novel management approaches as discussed herein, broadband service providers can effectively utilize their slice-specific resources within the converged radio access network including cable and optical spectrum access, cross-domain resources reservation, mobility management and control decisions taking into consideration key aspects such as spectrum sensing, carrier allocation, dynamic switching of carriers, transport paths connecting the distributed RAN functions, capacity and coverage performance, traffic density, UAV devices and applications with targeted quality of service in the most efficient, cost-effective and timely manner.

These and other examples as discussed herein are beneficial to provide better use of available wireless resources.

More specifically, one implementation as discussed herein includes a communication management resource configured to control connected paths through multiple networks. The communication management resource receives first input indicating network nodes of a first network. The communication management resource further receives second input indicating multiple data transport paths in a second network, where the data transport paths in the second network support connectivity between pairs or pairings of the network nodes in the first network. Based on the first input and the second input, the communication management resource controls operation of the first network and the second network to establish a communication path (such as a so-called midhaul path or other suitable type of path) supporting a communication session between a first communication device (such as a wireless communication device or a wired communication device) and a remote device such as a second communication device or other entity.

In accordance with further examples as discussed herein, the second network can be configured to support multiple data transport paths including at least a first data transport path and a second data transport path. In order to support a quality of service assigned to the mobile communication device requesting service, the communication management resource can be configured to: i) select the first data transport path of the multiple data transport paths, ii) select a first pair of network nodes from the network nodes in the first network, and iii) establish the communication path to include the first data transport path and the first pair of network nodes in the first network. The combination of the first data transport path and the first pair of network nodes are selected because such a combination supports conveyance of data packets associated with the communication device in accordance with the corresponding quality of service assigned to the first communication device. Additionally, it is noted that the selected first pair of network nodes may include a first network node and a second network node. Establishment of the communication path may include the communication management resource establishing series connectivity including the first data transport path disposed between the first network node and the second network node.

Yet further, it is noted that the first network node may be a so-called distributed unit (DU) node of the first network supporting DU (Distributed Unit) functionality; the second network node may be a so-called central unit (CU) node of the first network supporting CU (Central Unit) functionality.

In accordance with still further examples as discussed herein, the communication management resource can be configured to produce control information controlling conveyance of communications over the communication path through the second network and communicate the control information to the second network. The second network can be configured to execute the control information (such as data path control settings) to provide a quality of service of conveying communications in accordance with a quality of service assigned to the mobile communication device.

It is noted that the different networks as discussed herein can be operated by different network service providers. For example, the first network may be operated by a first network service provider; and the second network may be operated by a second network service provider independent of the first service provider.

In further examples as discussed herein, the multiple data transport paths in the second network may include a first data transport path and a second data transport path. To support a quality of service assigned to the mobile communication device, the communication management resource can be configured to: i) select the first data transport path of the multiple data transport paths, ii) select a first pair of network nodes from the network nodes in the first network, iii) establish the communication path to include the first data transport path and the first pair of network nodes in the first network, and iv) in response to detecting degradation of the first data transport path, implement the second data transport path as a substitute for the first data transport path to support the communication path.

Yet further, in a similar manner as previously discussed, it is noted that the communication management resource can be configured to select a first pair of network nodes from first network, where the first pair of network nodes includes a first network node and a second network node. The communication management resource selects the first network node and the second network node because they are determined to have the ability to provide the appropriate quality of service of conveying communications on behalf of the requesting communication device. A data transport path is needed between the selected first network node and the selected second network node. The communication management resource selects a first data transport path from the multiple data transport paths in the second network because the first data transport path is determined to have the ability to support the quality of service as required by the requesting communication device. The communication management resource then establishes the communication path to include the first data transport path extending between the first network node and the second network node, where the communication session supports conveyance of communications encoded in accordance with a wireless communication protocol. In other words, one or more of the communications conveyed over the communication path may be encoded in accordance with a wireless communication protocol. In one example, the first network node is configured to support first network layer processing (such as at one or more layers) of a network layer stack; the second network node is configured to support second network layer processing (such as at one or more layers) of the network layer stack.

In accordance with yet further examples as discussed herein, the communication management resource receives first input associated with a first network configured to provide wireless connectivity to a mobile communication device requesting to establish a communication path to a second communication device through the first network (such as a network supporting wireless communications). The communication management resource also receives second input associated with a second network supporting second connectivity (such as midhaul connectivity or other suitable type of connectivity) between the first network and the second communication device. Based on the first input and the second input, the communication management resource manages operation of the first network (supporting the wireless connectivity) and the second network to establish a communication path between the mobile communication device and the remote communication device over a combination of the first network and the second network.

In one example, the first input received by the communication management resource includes communication link performance/quality of service information (such as minimum throughput bandwidth settings, maximum latency settings, maximum packet error rate settings, etc.) assigned to the mobile communication device. The communication link performance information thus indicates a quality of service requirements assigned to the mobile communication device. In furtherance of controlling operation of the first network and the second network, the communication management resource produces control information (such as network settings) controlling conveyance of the communications over the communication path through the second network. The communication management resource or other suitable entity then communicates the control information to the second network. The second network is operative to execute the control information (communication path settings) to provide the quality of service assigned to the mobile communication device.

Accordingly, the communication management resource as discussed herein can be configured to coordinate or control operations associated with multiple networks to provide a respective mobile communication device a corresponding assigned data conveyance performance over a communication path through multiple disparate networks.

In another example, the first wireless network is operated by a first wireless network service provider; the second wireless network is operated by a second wireless network service provider independent of the first wireless network service provider.

The techniques as discussed herein are useful because the centralized communication management resource supports more efficient conveyance of communications through multiple networks including the first network and the second network. For example, the communication management resource as discussed herein can be configured to receive information regarding pairings of network nodes in the first network as well as available communication paths in the second network. Each of the available communication paths in the second network support a corresponding quality of service of conveying respective communications. The communication management resource further receives quality of service information indicating a quality of service to be provided to the requesting mobile communication device. In order to provide the specified quality of service (associated with the mobile communication device) between a first pairing of network nodes selected to support the communications associated with the mobile communication device, the communication management resource for selects the appropriate first pairing of network nodes capable of providing the desired quality of service. The communication management resource then selects a first communication path from the second network supporting the quality of service, where the first communication path is configured to support conveyance of communications between the first pairing of network nodes, resulting in the appropriate quality of service provided to the mobile communication device through a combination of the first pair of network nodes in the first network as well as the first communication path selected from the second network.

Note that any of the resources as discussed herein can include one or more computerized devices, communication management resources, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including computer readable storage hardware (such as hardware to store executable instructions), or non-transitory computer-readable storage media, etc., on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a computer readable storage hardware or medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed on a computerized device to cause the computerized device to perform the techniques explained herein.

Accordingly, examples herein are directed to a method, system, computer program product, etc., that supports operations as discussed herein.

One example as discussed herein includes a computer readable storage medium and/or system having instructions stored thereon to facilitate better use of available wireless resources in a network environment. The instructions, when executed by computer processor hardware, cause the computer processor hardware (such as one or more co-located or disparately processor devices or hardware) to: receive first input indicating network nodes of a first network; receive second input indicating multiple data transport paths in a second network, the data transport paths supporting connectivity between pairs of the network nodes in the first network; and based on the first input and the second input, control operation of the first network and the second network to establish a communication path supporting a communication session between a mobile communication device and a remote entity.

Note that the ordering of the steps above has been added for clarity sake. Further note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of network access. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a network environment including multiple different networks and a corresponding communication management resource coordinating/controlling connectivity through the network environment between a first communication device and a second communication device as discussed herein.

FIG. 2 is an example flow diagram illustrating operations associated with establishing a communication path through multiple different networks as discussed herein.

FIG. 3 is an example flow diagram illustrating operations associated with establishing a communication path through multiple different networks as discussed herein.

FIG. 4 is an example flow diagram illustrating operations associated with establishing a communication path through multiple different networks as discussed herein.

FIG. 5 is an example diagram illustrating access control via mid-haul cable transport resources as discussed herein.

FIG. 6 is an example diagram illustrating access control via mid-haul transport resources as discussed herein.

FIG. 7 is an example diagram illustrating dynamic path switching and control using mid-haul transport resources as discussed herein.

FIG. 8 is an example diagram illustrating dynamic access slice switching and control using mid-haul transport resources as discussed herein.

FIG. 9 is an example diagram illustrating dynamic access slice switching and control using mid-haul transport resources as discussed herein.

FIG. 10 is an example diagram illustrating example computer architecture operable to execute one or more operations as discussed herein.

FIG. 11 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

One example as discussed herein includes a communication management resource configured to control connectivity of paths through multiple networks. For example, the communication management resource initially receives first input indicating network nodes of a first network as well as performance information indicating quality of service of conveying communications provided by each of the available network nodes in the first network, where the network nodes are configured to support wireless connectivity in a network environment. The communication management resource further receives second input indicating multiple data transport paths in a second network as well as performance information indicating quality of service of conveying communications provided by each of the available data transport paths, where the data transport paths support connectivity between pairs or pairings of the network nodes in the first network.

In response to receiving a request from a communication device to establish connectivity through a combination of the first network and the second network, the communication management resource selects a combination of network nodes in the first network and one or more data transport paths in the second network that supplies an appropriate performance (quality of service) of conveying communications through the first network and the second network on behalf of the first communication device.

Based upon the selected combination of resources, the communication management resource generates control information (communication path settings) and supplies the corresponding set of control commands to the first network and the second network to establish the connectivity (communication path) supporting a communication session between the first communication device (such as a wireless communication device) and a remote device such as a second communication device or other entity.

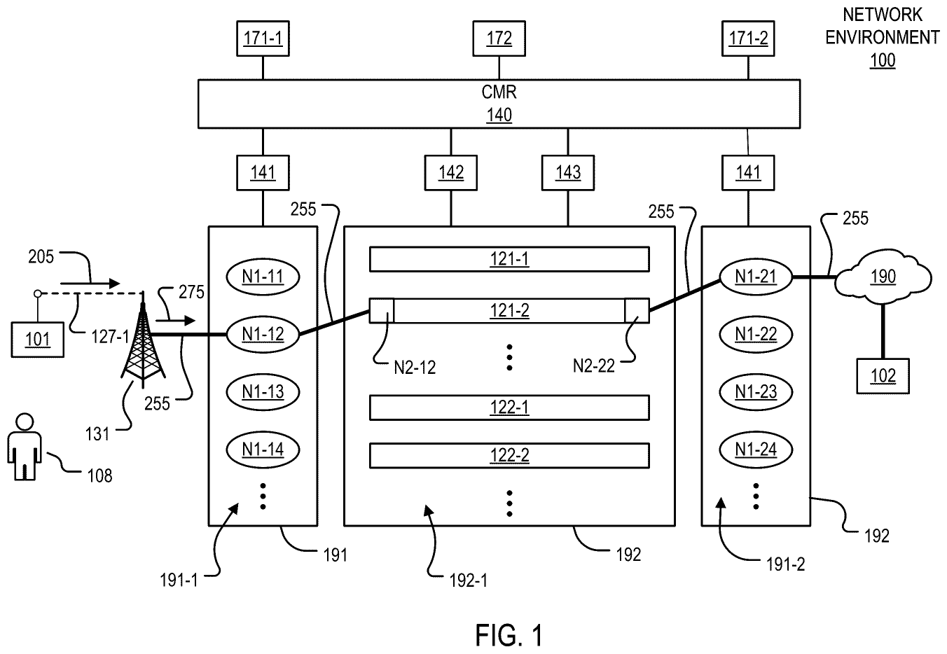

Now, more specifically, with reference to the drawings, FIG. 1 is an example diagram illustrating a network environment including multiple different networks and a corresponding communication management resource coordinating/controlling connectivity through the network environment between a first communication device and a second communication device as discussed herein.

As shown, the network environment 100 shown in FIG. 1 includes mobile communication device 101 (a.k.a., user equipment), mobile communication device 102 (a.k.a., user equipment), communication management resource 140, communication management resource 141 (such as including communication management resource 141-1, and communication management resource 141-2), communication management resource 142, communication management resource 143, wireless base station 131 or wired base station, network 191 (including resources 191-1, network resources 191-2, etc.), and network 192.

The network resources 191-1 in network 191 include multiple network nodes such as network node N1-11, network node N1-12, network node N1-13, network node N1-14, etc. It is noted that the network 191 may be a wireless network, a wired network, etc.

The network resources 191-2 in the network 192 include multiple network nodes such as network node N1-21, network node N1-22, network node N1-23, network node N1-24, etc. It is noted that the network 192 may be a wireless network, a wired network, etc.

It is further noted that the wireless communication link 127-1 supports conveyance of communications 275 (such as data packets) from the communication device 101 to the wireless base station 131. As further shown, the network 191 and corresponding network resources 191-1 and network resources 191-2 support conveyance of those data packets associated with communications 275 over the communication path 255, which may include a so-called mid-haul communication path.

It is noted that the wireless base station 131 is shown by way of nonlimiting example only. The connectivity (such as the communication link 127-1) between the communication device 101 and the base station 131 may be a wired connection or physical connection such as a physical communication link between the communication device 101 and the base station 131 if desired.

The network 191 and corresponding network resources 191-1 are controlled by the communication management resource 141; the network resources 191-2 in the network 191 are controlled by the communication management resource 141.

The network 192 includes the data transport path 121-1, data transport path 121-2, etc., data transport path 122-1, data transport path 122-2, etc. Each of the data transport paths may be supported by a wired network, a wireless network, or a combination of a wired network (a.k.a., physical network, physical communication links, etc.) and wireless network.

In one example, the data transport paths 121-1, 121-2, etc., in the network 192 are controlled by the communication management resource 142. Such data transport paths controlled by the communication management resource 142 may be implemented via cable modem resources such as one or more instances of a cable modem and corresponding cable modem termination system.

The data transport paths 122-1, 122-2, etc., in the network 192 are controlled by the communication management resource 143. Such data transport paths controlled by the communication management resource 143 may be implemented via passive optical network resources such as one or more instances of optical network termination nodes and an optical line termination system.

As further shown, the communication management resource 140 is in communication with each of the communication management resource 141, communication management resource 142, and communication management resource 143.

The communication management resource 140 can be configured to monitor a performance associated with the network resources 191-1 and their ability to support conveyance of communications through the network 191. The communication management resource 140 store/access performance information 171-1 indicating the ability of each of the different network resources 191-1 in network 191 to support conveyance of communications through the network 191.

The communication management resource 140 can be configured to monitor a performance associated with the network resources 191-2 and their ability to support conveyance of communications through the network 191. The communication management resource 140 store/access performance information 171-2 indicating the ability of each of the different network resources 191-2 in network 191 to support conveyance of communications through the network 191.

The communication management resource 140 can be configured to monitor a performance associated with the network resources 192-1 and their ability to support conveyance of communications through the network 192. The communication management resource 140 store/access performance information 172 indicating the ability of each of the different network resources 192-1 in network 192 to support conveyance of communications through the network 192.

In this example, the user 108 operating the communication device 101 generates a respective request in communications 205 to establish connectivity through a combination of the network 191 and the network 192 to the communication device 102. As further discussed below in the following FIGS. and text, in response to receiving notification of the request, the communication management resource 140 selects multiple network resources such as network node N1-12, data transport path 121-2, and the network node N1-21 to establish the corresponding communication path 255, which supports subsequent conveyance of communications 275 between the communication device 101 and the communication device 102. The communication management resource 140 uses the performance information 171-1, performance information 171-2, and performance information 172, to ensure that each of the selected multiple network resources and corresponding resulting communication path 255 supports a quality of service as required by the communication device 101. The data transport path 121-2 in this example includes a first terminal node N2-12 and a second terminal node N2-22.

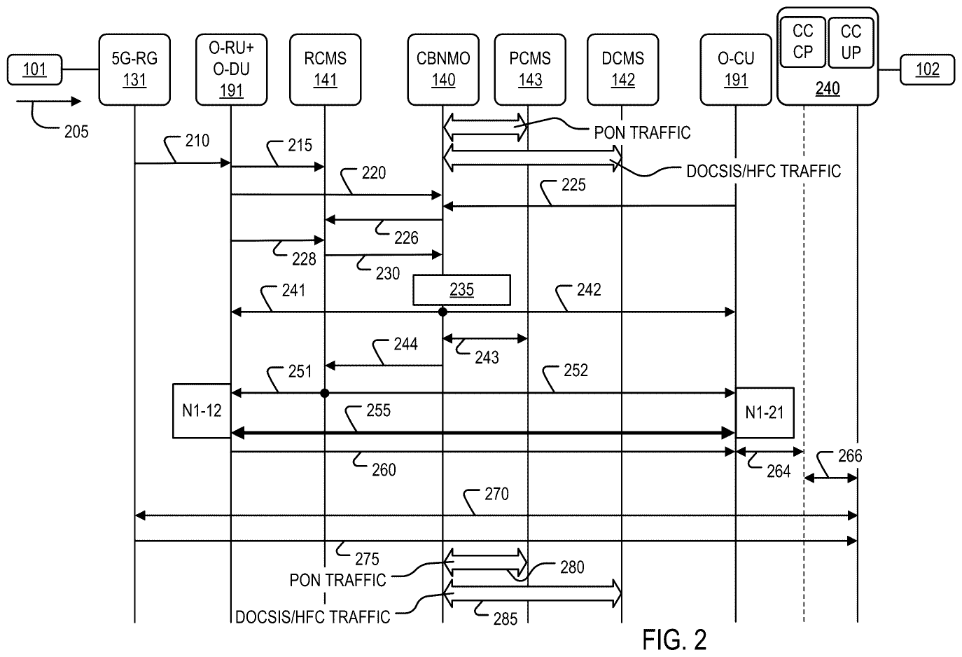

FIG. 2 is an example flow diagram illustrating operations associated with establishing connectivity through multiple different networks as discussed herein.

In this example, the user 108 operating the communication device 101 (such as supporting 5G communications or other wireless communication protocol) requests to establish a communication session with the communication device 102. In such an instance, the wireless base station 131 (such as a residential gateway supporting 5G or other communications) receives the request in communications 205 transmitted from the communication device 101 over a wireless communication link 127-1. In response to receiving the request in communications 205 to establish the connectivity (supporting a new communication session), the wireless base station 131 in the network 191 transmits communications 210 to the network 191.

In one example, the communications 210 indicate information associated a new user 108 and corresponding communication device 101 attempting to gain access into the 5G system with an intent driven application (such as based on location, service flow type, flow priority, slice, flow SLA, etc.). In other words, the communications 210 notify the network 191 regarding what quality of service or performance is to be provided to communications conveyed over the new communication session (and communication path 255) established on behalf of the communication device 101 to communicate with the communication device 102.

In response to receiving the communications 210, the network 191 (supporting one or more RU and DU resources) transmits communications 215 to the communication management resource 141 associated with the network 191. The communications 215 may include DU management information associated with the network 191 and a corresponding DU function (such as in network node N1-12 or other suitable entity) providing the newly requested service to the communication device 101. Additionally, via communications 220, the network 191 and corresponding DU function notifies the communication management resource 140 regarding the DU management information associated with the network 191 and corresponding DU (network node N1-12 associated with the wireless base station 131) providing the newly requested service to the communication device 101. Note that the communications 220 may further indicate any of the network nodes in the network 191 available to support DU functions.

Additionally, via communications 225 (such as CU management information associated with any of the network resources 191-2 exchanged with the communication management resource 140), the network 191 such as managing one or more instances of resources (191-2) such as providing CU functionality at one or more network nodes in the network 191 provides notification of CU management information associated with the network 191. The communications 225 may indicate availability of different network nodes in the network 191 and corresponding supported CU functionality, where the CU functionality is to be paired with the DU functionality provided by a selected one of the network resources 191-1 such as node N1-12 or other network node selected to provide the CU functionality associated with the communication path 255.

Further, via communications 226, the communication management resource 140 communicates with the communication management resource 141 to provide notification of the request to establish the new communication session (communication path 255).

Via communications 228 (such as including the user service flow intent information exchanged with the communication management resource 141), further in response to receiving the request to establish the new communication session in communication path 255 on behalf of the communication device 101, the wireless network 191 provides notification of a requested user service flow (indicating attributes such as bandwidth, latency, quality of service, performance, etc.) associated with the new communication session and new communication path to the communication management resource 141.

In response to receiving the communications 228, the communication management resource 141 transmits the communications 230 (such as so-called RCMS queries to the communication management resource 140 to determine the optimal path such as a PON data transport path or a DOCSIS data transport path through the network 192 for a respective requested new service flow based on transport path level latency) to the communication management resource 140. This information in communications 230 notifies the communication management resource 141 of a respective quality of service, performance, latency, etc., that must be supported by the newly established communication path 255.

In processing operation 235, based on receiving the communications 230 indicating the quality of service to provide by the communication path 255, and in response to receiving notification of the corresponding request to determine an optimal path to support the requested new connectivity and communication session by the communication device 101, the communication management resource 140 overseeing the first network 191 and the second network 192 performs an analysis (processing operation 235) of the available data transport paths in the network 192 to determine the best possible or appropriate latency path to implement between a given pair of network nodes (CU-DU) in the first network 191, where the selected data transport path in the network 192 needs to support the requested service flow performance based on time of day, availability of data transport paths, utilization, location of the communication device 101 and the wireless base station 131, and corresponding service criteria such as performance to be provided to the communication device 101 and corresponding data flow over the communication session being established.

Recall that the communication management resource 140 or other suitable entity continuously monitors performance associated with each of the network resources 191-1, network resources 191-2, and the different data transport paths 122 in the second network 192.

The monitoring of performance information may include the communication management resource 140 continuously receiving feedback from the communication management resource 141 or other suitable entity regarding the performance associated with each of the network resources 191-1 and their ability to support conveyance of communications. The communication management resource 140 produces and stores the performance information 171-1, indicating the performance capability associated with each of the network resources 191-1 in the network 191. As previously discussed, the received feedback may indicate any type of performance parameters such as a latency associated with each respective network node processing communications and forwarding those communications through the network.

The monitoring of performance information may include the communication management resource 140 continuously receiving feedback from the communication management resource 141 regarding the performance associated with each of the network resources 191-2 and their ability to support conveyance of communications. The communication management resource 140 produces and/or stores the performance information 171-2 to indicate the performance capability associated with each of the network resources 191-2 in the network 191. As previously discussed, the received feedback may indicate any type of performance parameters such as a latency associated with each respective network node processing communications and forwarding those communications through the network.

The monitoring of performance information may include the communication management resource 140 continuously receiving feedback from the communication management resource 142 regarding the performance associated with each of the network resources 192-1 (such as data transport paths) and their ability to support conveyance of communications through the network 192. The communication management resource 140 produces and stores the performance information 172 to indicate the performance capability associated with each of the network resources 192-1 in the network 191. As previously discussed, the received feedback may indicate any type of performance parameters such as a latency associated with each respective data transport path processing communications and forwarding those communications through the network.

Accordingly, the communication management resource 140 has knowledge about the different performance capabilities (performances) of the resources in the different networks. In one example, the wireless network 191 and corresponding resources are provided and managed by a first wireless network service provider. The second network 192 may be operated by a second network service provider different than the first network service provider

In a further example, processing operations 235 include receiving input indicating the appropriate performance/quality of service be provided to the newly established communication session. The communication management resource 140 uses the performance information 171-1, performance information 171-2, and performance information 172 to determine an appropriate combination of resources from each of the different networks to establish a respective communication path 255 supporting the performance and quality of service as required by the newly established communication session. In one example, the communication management resource 140 receives quality of service information such as a need to support conveyance of communications over the communication path 255 with a delay time less than a specified threshold value. The performance information associated with each of the different components in the networks may indicate a delay time associated with each of the different available network resources. The communication management resource 140 selects amongst the different resources in the communication path such that the overall delay over the communication path 255 (provided by combination of the selected network resources) is less than the specified threshold value.

Subsequent to determining (such as via operations 235) the one or more appropriate data transport paths in the network 192 that will support the performance required by the newly requested communication session by the communication device 101, the communication management 140 resource transmits communications 241 to the network 191. In one example, the communications 241 indicate one or more data transport paths available for use by the network 191 between a respective pair of network nodes (CU-DU) and network 191.

Further, subsequent to determining the one or more appropriate data transport paths in the network 192 that will support the newly requested communication session by the communication device 101, the communication management 140 resource transmits communications 242 to the wireless network 191. In one example, the communications 241 indicate one or more data transport paths available for use by the network 191 between a respective pair of network nodes (CU-DU) in network 191, where the available data transport paths support the desired quality of service/performance.

Via communications 243, the communication management resource 140 notifies the communication management resource 143 of a selected data transport path (such as data transport path 121-2 in this example) to the used to support the newly established communication session on behalf of the communication device 101. The data transport path 121-2 may support DOCSIS communications or PON communications or any type of communications.

Via further communications 244, the communication management resource 140 notifies the communication management resource 141 regarding the selection of the data transport path 121-2 to support the newly established communication session.

Via communications 251, in response to receiving notification of the selected data transport path 121-2 (and corresponding terminal node N2-12 and terminal mode N2-22) from the communication management resource 140, the communication management resource 141 communicates with the resources in the network 191 to configure the selected node N1-12 associated with the wireless base station 131 to provide CU functionality associated with the newly established communication session. Additionally, via communications 252, the communication management resource 141 communicates with the network 191 to configure the selected node N1-21 to provide DU functionality associated with the newly established communication session in communication path 255.

As previously discussed, assume that the communication management resource 140 selects a combination of the network node N1-12 to provide CU functionality associated with the new communication session, data transport path 121-2 to support conveyance of data associated with the new communication session, and network node N1-21 to provide DU functionality associated with the communication session. In order to support the communication path 255, the communication management resource 140 also provides notification to the communication management resource 141 that the selected node N1-12 providing DU functionality is to connect to the terminal node N2-12 of the data transport path 121-2 and that the selected node N1-21 providing CU functionality is to connect to the node N2-22 of the data transport path 121-2.

Accordingly, the communication management resource 140 establishes the communication session to include a communication path 255 (such as so-called mid-haul cable transport) through the first network 191 and the second network 192, where the communication path 255 supports the new communication session between the communication device 101 and the communication device 102. Based on selection by the communication management resource 140, the newly established communication path to 255 includes a combination of the selected node N1-12 in network 191 providing CU functionality, data transport path 121-2 providing conveyance of data associated with the new communication session, and the selected node N1-21 in the network 191 providing DU functionality.

As previously discussed, the communications conveyed over the communication path 255 may be encoded in accordance with 5G protocol and 5G protocol stack, where the selected DU functionality associated with the transmitted data packets (communications 275) performs processing at the one or more layers such as the high physical layer, MAC layer or layers (such as the so-called High Mac layer and/or low MAC layer), and/or one or more radio link control layers (RLC) (such as high RLC layer and/or low RLC layer) in a network stack. The selected CU functionality supports processing at one or more layers or functions such as data layer, PDCP layer, PCAP (Packet Capture), SDAP (Service Data Adaptation Protocol), and RRC (Radio Resource Control) layer processing associated with the data packets conveyed over the communication path 255. Accordingly, the combination of the selected pair of nodes in the first network support split layer processing.

As previously discussed, it is noted again that the data transport path 121-2 can be configured to include a first terminal such as node N2-12 (such as a cable modem or optical network termination) and a second terminal such as node N2-22 (such as a cable modem termination system or optical line termination). In other words, the data transport path 121-2 may be cable modem network path or a passive optical network path disposed in the network 192.

As further shown, the communication path 255 can be configured to support conveyance of DU traffic (communications 260) transmitted from the node N1-12 to the node N2-12 of the data transport path 121-2. The node N2-12 can be configured to tag the DU traffic (communications 260 such as upstream or uplink communications) for conveyance over the data transport path 121-2 to the termination node N2-22. The termination node N2-22 uses the tag information to determine that the DU traffic transmitted over the data transport path 121-2 is conveyed on behalf of the newly established communication session to the communication device 102. The termination node N2-22 forwards the DU traffic to the node N1-21 (supporting the CU functionality) in the network 191.

Accordingly, the different resources and communication path 255 as established by the communication management resource 140 and corresponding communication management resources 141/142/143 support conveyance of communications over the communication path 255 between the selected pair of nodes including node N1-12 (such as providing CU functionality associated with wireless network) and the node N1-21 (such as providing DU functionality associated with the wireless network) over the data transport path 121-2 between the node N2-12 and the node N2-22.

As shown, the communication path 255 supports the new communication session 270 on behalf of the requesting communication device 101.

As further shown, the communication path between the communication device 101 and the communication device 102 may include communications 275 (such as data packets encoded in accordance with a wireless protocol such as 5G protocol supported by the wireless communication link 127-1) such as user plane uplink traffic (i.e., data packets) from the communication device 101 through the communication resources 240 (such as CC-CP, also known as component carrier control plane and the CC-UP, also known as component carrier user plane) to the communication device 102.

As previously discussed, the data packets transmitted between the node N2-12 and node N2-22 may be encapsulated and/or encrypted for secure routing of those data packets through the second wireless network 192.

Implementation of the system and corresponding implementation of one or more management operations of managing multiple networks (wireless networks, wired networks, etc.) provides better connectivity between a first communication device 101 and a second communication device 102. For example, one specific implementation of a communication management resource 140 as discussed herein includes a so-called converged broadband network management orchestration system (CBNMO or otherwise known as a communication management resource) that orchestrates multi-access domain management systems with open standards APIs to deliver next generation services.

The communication management resource 140 as discussed herein can be dynamically configured to function as an integrated network management system across the multi-access, transport and core networking domains (such as network 191 and network 192) with cross-domain mapping and traffic correlators for targeted end-to-end application performance metrics such as KPI/KCIfor other metrics and corresponding evaluation based on the monitored performance feedback information. In addition, as further discussed below, the communication management resource 140 can be configured to orchestrate broadband access domain slice-specific management system with integrated slice-mapping functions and associated slice specific latency across each domain. Further, the communication management resource 140 is capable of ingesting the latency APIs from each of the access, transport and core domain management systems at the slice level.

Based on the novel management approaches as discussed herein, broadband service providers can effectively utilize their slice-specific resources within the converged radio access network including cable and optical spectrum access, cross-domain resources reservation, mobility management and control decisions taking into consideration key aspects such as spectrum sensing, carrier allocation, dynamic switching of carriers, transport paths connecting the distributed RAN functions, capacity and coverage performance, traffic density, UAV (Unmanned Aerial Vehicle) devices and applications with targeted quality of service in the most efficient, cost-effective and timely manner.

Thus, one implementation as discussed herein includes a communication management resource configured to control connection of multiple paths through multiple networks to support end-to-end conveyance of communications. More specifically, the communication management resource 140 receives first input indicating network nodes of a first network as well as receives performance information 171-1 and performance information 171-2 associated with the network nodes in the first network, where the network nodes are configured to support wireless connectivity in a network environment. The communication management resource 140 further receives second input indicating multiple data transport paths in a second network as well as feedback indicating the performance associated with the performance of the data transport paths in the second network. The communication management resource 140 selects one or more data transport paths in the second network to support connectivity between pairs or pairings of the network nodes in the first network. Based on the first input and the second input, the communication management resource 140 controls operation of the first network 191 and the second network 192 to establish a communication path 255 supporting a communication session between a first mobile communication device 101 (such as a wireless communication device) and a remote device such as a second communication device 102 or other entity. Thus, instead of the individual networks and corresponding communication management resources 141, 142, and 143, managing the establishment of the communication path 255, the communication management resource 140 network resources to be included in the communication path 255

In accordance with further examples as discussed herein, the second network 182 can be configured to support multiple data transport paths including at least a first data transport path and a second data transport path. In order to support quality of service assigned to the mobile communication device requesting service, the communication management resource 140 can be configured to: i) select the first data transport path 121-2 of the multiple data transport paths, ii) select a first pair of network nodes such as network node N1-12 and network node N1-21 from the network nodes in the first network, and iii) establish the communication path (255) to include the first data transport path 121-2 and the first pair of network nodes in the first network. Establishment of the communication path may include the communication management resource establishing series connectivity including the first data transport path 121-2 disposed between the first network node (N1-12) and the second network node (N1-21).

Yet further, it is noted that the first selected network node N1-12 may be a so-called distributed unit (DU) node of the first network; the second network node N1-21 may be a so-called central unit (CU) node of the first network.

In accordance with still further examples as discussed herein, the communication management resource 140 can be configured to produce control information controlling conveyance of communications over the communication path 255 through the second network 192. The communication management resource 140 can be configured to communicate the control information (such as indicating the different selected network resources to support the communication path 255) to the second network. The second network can be configured to execute the control information (configuration settings) to set up the respective communication path 255 to provide a quality of service of conveying communications in accordance with a quality of service assigned to the mobile communication device 101.

In further examples as discussed herein the multiple data transport paths in the second network may include a first data transport path 121-1 and a second data transport path 121-2. To support a quality of service assigned to the mobile communication device 101, the communication management resource 140 can be configured to: i) select the second data transport path 121-2 of the multiple data transport paths, ii) select a first pair of network nodes (network node N1-12 and network node N1-21) from the network nodes in the first network 191, iii) establish the communication path 255 to include the second data transport path 121-2 and the first pair of network nodes in the first network, and iv) in response to detecting degradation of the first data transport path 121-2, implement the data transport path 121-1 or other appropriate path providing appropriate quality of service as a substitute for the data transport path 121-2 to support the communication path (255).

In one example, the first input received by the communication management resource 140 includes communication link performance information (such as minimum throughput bandwidth settings, maximum latency settings, maximum packet error rate settings, etc.) assigned to the mobile communication device 101. The communication link performance information thus indicates a quality of service assigned to the mobile communication device. In furtherance of controlling operation of the first network and the second network, the communication management resource produces control information controlling conveyance of the communications over the communication path 255 through the second network. The communication management resource or other suitable entity then communicates the control information to the second network. The second network is operative to execute the control information (such as commands or other connectivity setting information) to provide the quality of service assigned to the mobile communication device.

Accordingly, the communication management resource 140 as discussed herein can be configured to coordinate or control operations associated with multiple networks to provide a respective mobile communication device a corresponding assigned communication link performance over a communication path through multiple disparate networks.

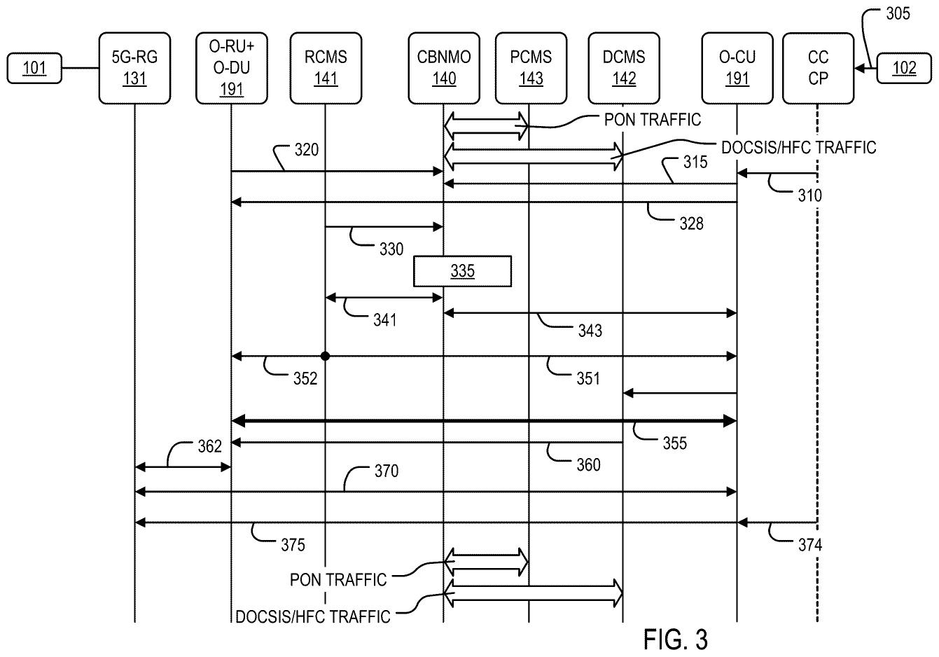

FIG. 3 is an example flow diagram illustrating operations associated with establishing connectivity through multiple different networks as discussed herein.

In this example, the communication device 102 establishes connectivity through the multiple networks including network 191 and network 192 to the communication device 101. The operations and communications in this example are similar to the operations as previously discussed with respect to FIG. 2, but in the opposite direction.

More specifically, in this example as shown in FIG. 3, the user operating the communication device 102 (such as supporting 5G communications or other wireless communication protocol) requests to establish a communication session with the communication device 101. In such an instance, the communication management resource 240 such including a wireless base station or other suitable entity (such as a residential gateway or other suitable entity supporting 5G or other communications) receives the request in communications 305 transmitted from the communication device 102 over a wireless communication link or other type of connection. In response to receiving the request in communications 305 to establish the connectivity (supporting a new communication session), the communication management resource 240 associated with the network 191 transmits communications 310 to the network 191.

In one example, the communications 310 indicate information associated with a user operating corresponding communication device 102 attempting to gain access into the 5G system or wireless network 191 (such as based on location, service flow type, flow priority, slice, flow SLA, etc.). In other words, the communications 310 notify the network 191 regarding what quality of service or performance is to be provided to communications conveyed over the new communication session established on behalf of the communication device 102 to communicate with the communication device 101.

In response to receiving the communications 310, the network 191 (supporting one or more RU or Radio Unit and CU resources) transmits communications 315 to the communication management resource 141 associated with the network 191. Via communications 315 (such as CU management information associated with any of the network resources 191-2 exchanged with the communication management resource 140), the network 191 such as managing one or more instances of resources (191-2) such as providing CU functionality in the network 191 provides notification of CU management information associated with the network 191 and supported by the network resources 191-2. The communications 315 may indicate availability of different network nodes in the network 191 supporting desired CU functionality, where the CU functionality of a network node in the network 191 is to be paired with the DU functionality provided by a selected one of the network resources 191-1 in the network 191 in a manner as previously discussed.

Via communications 320, the network 191 notifies the communication management resource 140 regarding DU management information associated with the network 191 and corresponding available network nodes (such as resources 191-1) supporting DU functionality. Accordingly, the communications 320 may include DU management information associated with the network 191 and one or more corresponding DU functional nodes available for providing the newly requested service to the communication device 102.

Via communications 328 (such as including the user service flow intent information exchanged with the communication management resource 141), further in response to receiving the request to establish the new communication session on behalf of the communication device 102, the network 191 (supporting wireless communications in accordance with a wireless communication protocol such as 5G or other suitable protocol) provides notification of a requested user service flow (indicating attributes such as required bandwidth, latency, quality of service, performance, etc.) associated with the new communication session and new communication path 355 to the communication management resource 141 managing the network 191.

In response to receiving the communications 328, the communication management resource 141 transmits the communications 330 (such as RCMS queries to the communication management resource 140 to determine the optimal path such as a PON path or a DOCSIS path through the network 192 for a respective requested new service flow based on transport path level latency) to the communication management resource 140. The information in communications 328 can be configured to notify the communication management resource 141 of a respective quality of service, performance, latency, etc., that must be supported by the newly established communication path 355 on behalf of the communication device 102 and/or the communication device 101.

In processing operation 335, based on receiving the communications 330, and receiving notification of the corresponding request to determine an optimal path to support the requested new connectivity and communication session by the communication device 102, the communication management resource 140 overseeing/controlling the first network 191 and the second network 192 performs an analysis (processing operation 335) of the available data transport paths in the network 192 to determine the best possible latency path or quality of service path for a given pair of network nodes (CU-DU) in the first network 191, where the selected data transport path in the network 192 supports the requested service flow performance based on time of day, availability of data transport paths, utilization, location of the communication device 102 and the wireless base station 131, and corresponding service criteria such as performance to be provided to the communication device 102 and corresponding data flow over the communication session (communication path 355) to the communication device 101 being established.

Recall again that the communication management resource 140 continuously monitors performance associated with each of the network resources 191-1, network resources 191-2, and the different data transport paths in the second network 192.

The monitoring of performance information may include the communication management resource 140 continuously receiving feedback from the communication management resource 141 regarding the performance associated with each of the network resources 191-1 and their ability to support conveyance of communications. The communication management resource 140 produces and stores the performance information 171-1 to indicate the performance capability associated with each of the network resources 191-1 in the network 191. As previously discussed, the received feedback may indicate any type of performance parameters such as a latency associated with each respective network node processing communications and forwarding those communications through the network.

The monitoring of performance information may include the communication management resource 140 continuously receiving feedback from the communication management resource 141 regarding the performance associated with each of the network resources 191-2 and their ability to support conveyance of communications. The communication management resource 140 produces and stores the performance information 171-2 to indicate the performance capability associated with each of the network resources 191-2 in the network 191. As previously discussed, the received feedback may indicate any type of performance parameters such as a latency associated with each respective network node processing communications and forwarding those communications through the network.

The monitoring of performance information may include the communication management resource 140 continuously receiving feedback from the communication management resource 142 regarding the performance associated with each of the network resources 192-1 (such as data transport path) and their ability to support conveyance of communications through the network 192. The communication management resource 140 produces and stores the performance information 172 to indicate the performance capability associated with each of the network resources 192-1 in the network 191. As previously discussed, the received feedback may indicate any type of performance parameters such as a latency associated with each respective data transport path processing communications and forwarding those communications through the network.

Accordingly, the communication management resource 140 has knowledge about the different performance capabilities of the resources (network nodes providing CU functionality, network nodes providing DU functionality, and data transport paths) in the different networks. In one example, the wireless network 191 and corresponding resources are provided and managed by a first wireless network service provider. The second network 192 may be operated by a second network service provider different than the first network service provider

In one example, processing operations 335 include receiving input indicating the appropriate performance/quality of service be provided to the newly established communication session and corresponding communication path 355 on behalf of the communication device 102. The communication management resource 140 uses the performance information 171-1, performance information 171-2, and performance information 172 to determine an appropriate combination of resources from each of the different networks to establish a respective communication path 355 supporting the performance and quality of service as required by the newly established communication session.

Subsequent to determining (such as via operations 335) the one or more appropriate data transport paths in the network 192 that will support the performance required by the newly requested communication session by the communication device 102, the communication management 140 resource transmits communications 341/343 to the wireless network 191. In one example, the communications 341/343 indicate one or more data transport paths selected for use by the network 191 between a respective pair of network nodes (CU-DU) and network 191. The communications may also indicate a first network node in the wireless network 191 to provide DU functionality associated with the newly requested communication path as well as a second network node in the wireless network to provide CU functionality associated with the newly requested communication path.

Via communications 351, the communication management resource 141 notifies a first network node in the network 191 that is to provide CU functionality. The communications 351 may also indicate the selected data transport path of the wireless network to be used to establish the communication path 355.

Via communications 352, the communication management resource 141 notifies a second network node in the network 191 that is to provide DU functionality. The communications 352 may also indicate the selected data transport path in the wireless network to be used to establish the communication path 355.

In a similar manner as previously discussed, in response to receiving control information from the communication management resource 140 to establish the communication path 355 between the selected pair of network nodes using the selected data transport path, the network 191 and network 192 establish connectivity between the first network node selected to provide the CU functionality and the second network node selected to provide the DU functionality using the selected data transport path through the second network 192.

Accordingly, the communication management resource 140 establishes the requested communication session to include a communication path 355 (such as so-called mid-haul cable transport) through the first network 191 and the second network 192, where the communication path 355 supports the new communication session between the communication device 102 and the communication device 101. Based on selection by the communication management resource 140, the communication path 355 established by the network 191 and network 192 using selected resources as indicated by the communication management resource 140 includes a combination of the selected first node in network 191 providing CU functionality, selected data transport path providing conveyance of data associated with the new communication session, and the selected second node in the network 191 providing DU functionality.

As further shown via communications 360, CU data packets transmitted from the selected first node in the network 191 providing the CU functionality over the communication path 355 can be tagged with DOCSIS transport slice service VLANs or other tags to connect to the second node in the network 191 providing the DU functionality.

Via communications 362, the second network node (providing the DU functionality) in the network 191 delivers messages from the second node providing the DU functionality over a control plane to the target communication device 101.

Accordingly, the communication path 355 supports end-to-end communications 370 between the communication device 102 and the communication device 101.

Communications 374 represent incoming messages for delivery from a messaging center to the communication management resource 240. The communication management resource 140 transmits the communications 375 over the communication path 355, where the communications 375 support control plane message delivery from the communication management resource 240 over the communication path 355 to the communication device 101.

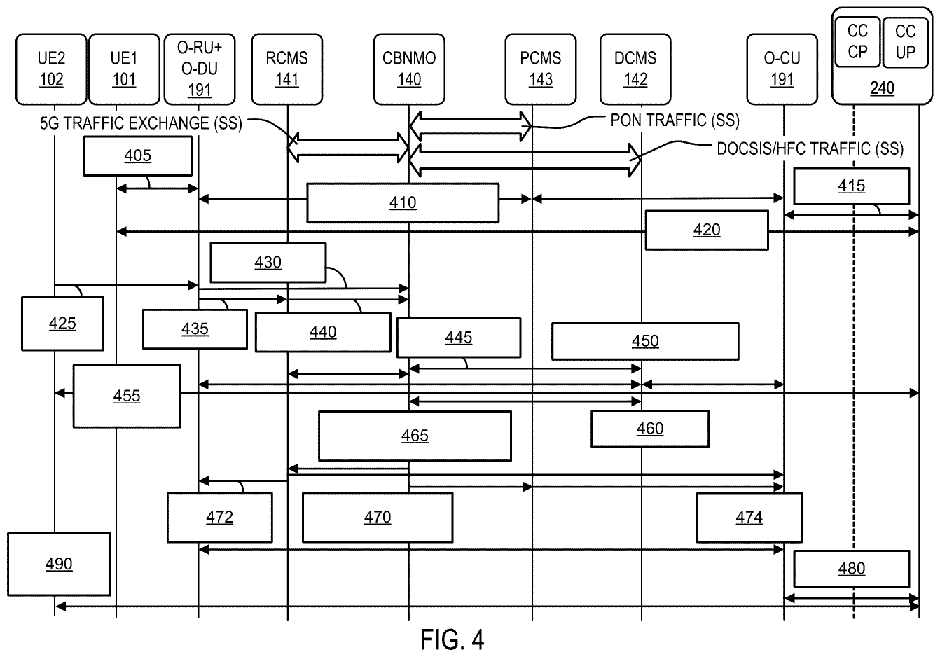

FIG. 4 is an example floItwiw diagram illustrating operations associated with establishing connectivity through multiple different networks as discussed herein.

This example illustrates dynamic coordinated switching of DU-CU functionality transport slice paths.

In processing operation 405, the communication device 101 connects with a respective first network node in the network 191 providing DU functionality for a respective URLCC service intent.

In processing operation 410, the DU functionality provided by the first network node in the network 191 is connected to a respective second node in the network 191 via a selected first data transport path of the second network 192, where the second node supports CU functionality in the first data transport path is selected by the communication management resource 140 in a manner as previously discussed. The network 192 includes the first data transport path (such as a passive optical network transport path for a cable modem transport path) between the first network node and the second network node in the network 191.

In processing operation 415, the network node in the wireless network 191 providing the CU functionality is connected to the communication management resource 240, where user data is exchanged.

Processing operation 420 corresponding communication support so-called E2E network data transfers via the selected first data transport path (such as a passive optical network mid-haul transport path in the network 192).

In processing operation 425, the communication device 102 connects with the same cell as communication device 101, where the communication device provides a request for a specific quality of service.

In processing operation 430, the wireless network 191 transmits DU functionality management information to the communication management resource 140. The DU functionality management information notifies the communication management resource 140 of the availability of the different network nodes in network 191 supporting DU functionality.

In processing operation 435, the wireless network 191 and corresponding network node providing DU functionality provides user service intent information associated with the communication device 102 to the communication management resource 141.

In processing operation 440, the communication management resource 141 implements a data transport path supporting a transport slice on behalf of the communication device 102.

In processing operation 445, the communication management resource 140 selects a data transport path in response to receiving the service request from the communication device 102. In a similar manner as previously discussed, the communication management resource 140 selects an appropriate first data transport path in the network 192 that provides sufficient quality of service/performance/latency as indicated by the requested service from the communication device 102.

In processing operation 450, the communication management resource 140 notifies the communication management resource 141 of the selected pair of network nodes in the network 191 that are to provide the CU functionality in the DU functionality. The communication management resource 140 further notifies the communication management resource 142 of the selected first data transport path to support the requested connection service.

In processing operation 455, the communication device 102 exchanges data with the communication management resource 240 over the selected first data transport path slice (such as a DOCSIS data transport path).

Further, in processing operation 460, the communication management resource notifies the communication management resource 140 of a detected network outage in which the first selected data transport path is no longer able to provide the connection service (such as over the originally established communication path) as requested by the communication device 102.

In processing operation 465, the communication management resource 140 decides to switch the first data transport path (experiencing the failure) assigned for use by the communication device 102 based on the detected network outage in the serving cell location and informs the communication management resource of a new data transport path allocation in the network 192. This may include selection of a second data transport path as a substitute for the first data transport path that no longer supports conveyance of data due to the detected network outage.

In processing operation 470, the communication management resource 140 notifies the communication management resource 141 regarding the switchover of the DU-CU transfer slice path from the first data transport path to a second data transport path due to the detected network outage. Accordingly, the new communication path is established using the combination of the first network node, the second data transport path, and the second network node.

In processing operation 472, the DU data packet traffic transmitted over the respective newly established communication path on behalf of the communication device 102 is tagged with appropriate information supporting the conveyance of that data packet traffic from the first node providing the DU functionality over the second data transport path (substitute path) to the second node providing the CU functionality.

In a reverse direction, in processing operation 474, CU data packet traffic at the second network node in the first wireless network is tagged with appropriate information supporting conveyance of that data packet traffic from the second node providing the CU functionality over the second data transport path to the first node providing the CU functionality.

In processing operation 480, the second network node in the wireless network 191 providing the CU functionality is connected to the communication management resource 240, where user data is exchanged.

In processing operation 490, communication device 102 exchanges data with the communication management resource 240 over the established communication path including the second data transport path.

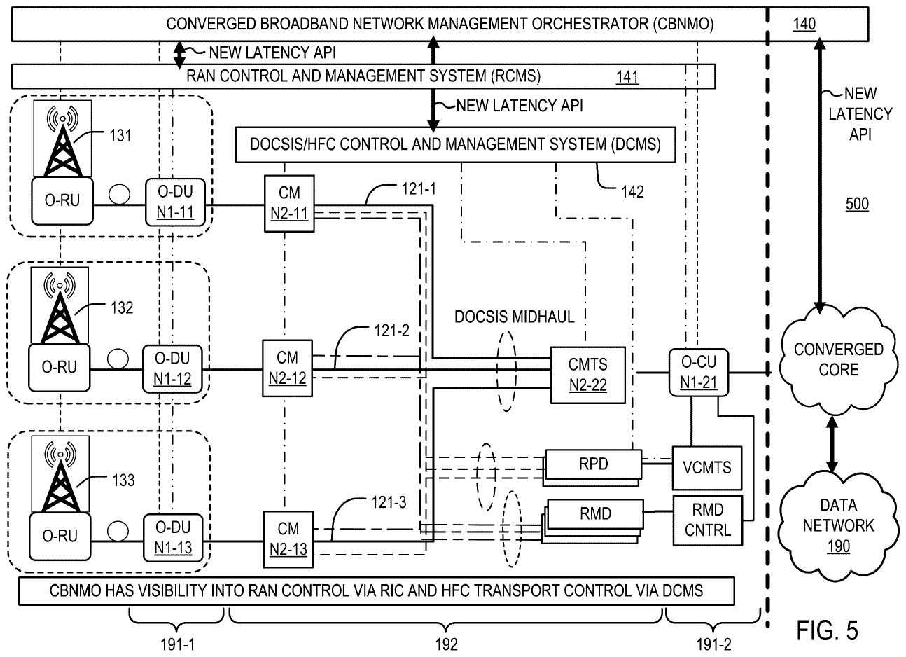

FIG. 5 is an example diagram illustrating access control via mid-haul cable transport resources as discussed herein.

In this example, the communication system 500 in FIG. 5 includes the different components as previously discussed such as communication management resource 140, communication management resource 141, communication management resource 142, wireless base station 131, wireless base station 132, wireless base station 133, . . . , network node N1-11, network node N1-12, network node N1-13, . . . , data transport path 121-1, data transport path 121-2, data transport path 121-3, etc. The communication system 500 supports access control to one or more communication devices via the communication management resource 140 controlling resources in the network 191 and the network 192 (and corresponding cable modem resources) to support requested connectivity.

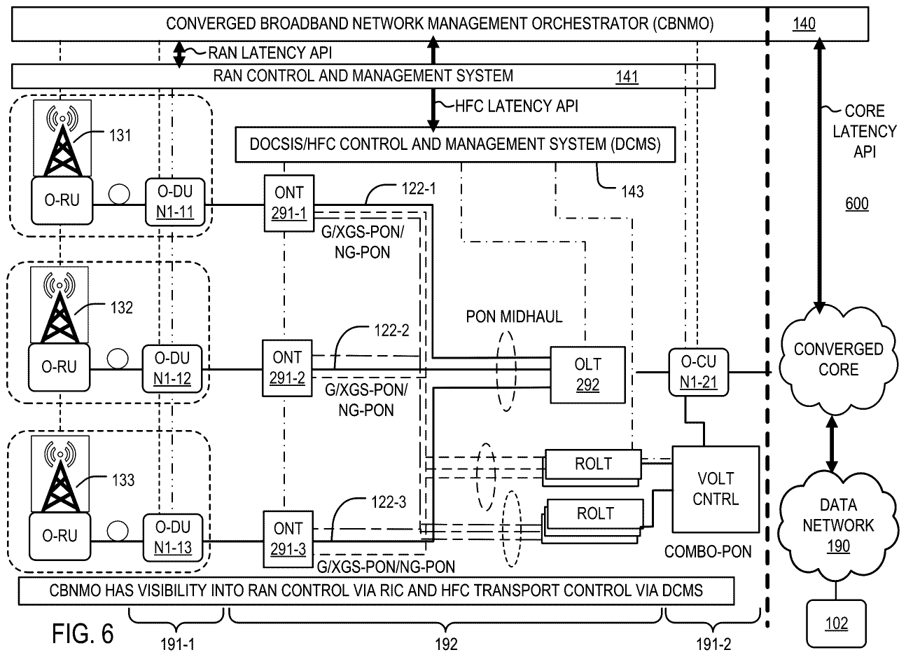

FIG. 6 is an example diagram illustrating access control via mid-haul transport resources as discussed herein.

In this example, the communication system 600 in FIG. 6 includes the different components as previously discussed such as communication management resource 140, communication management resource 141, communication management resource 142, wireless base station 131, wireless base station 132, wireless base station 133, . . . , network node N1-11, network node N1-12, network node N1-13, . . . , data transport path 121-1, data transport path 121-2, data transport path 122-1, etc. In a manner as previously discussed, the communication system 600 provides access control to one or more communication devices via the communication management resource 140 controlling resources in the network 191 and the network 192 (and corresponding passive optical network resources) to support requested connectivity.

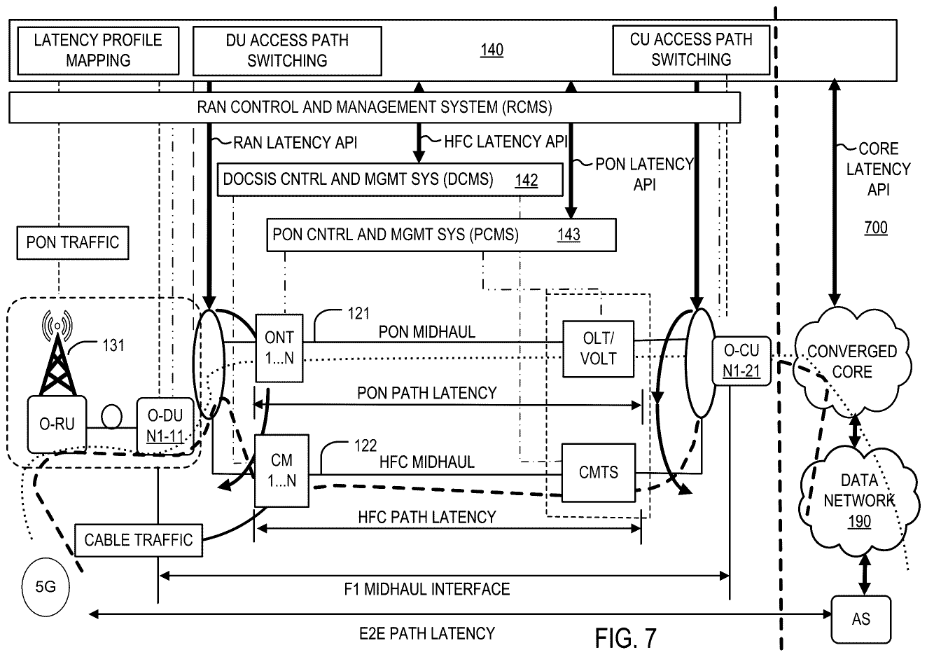

FIG. 7 is an example diagram illustrating dynamic path switching in control using mid-haul transport resources as discussed herein.

In this example, the communication system 700 in FIG. 7 includes the different components (communication management resource 140, communication management resource 141, communication management resource 142, wireless base station 131, etc., wireless network 191 and corresponding network nodes, wireless network 192 and corresponding data transport paths 121 such as supported by cable modem resources, data transport path 122 such as supported by passive optical network resources, ...) as previously discussed. The communication system 700 and corresponding communication management resource 140 supports dynamic path switching amongst different available resources in the network 191 and the network 192. The dynamic switching such as previously discussed with respect to FIG. 4 ensures that a respective communication path is provided an appropriate quality of service level.

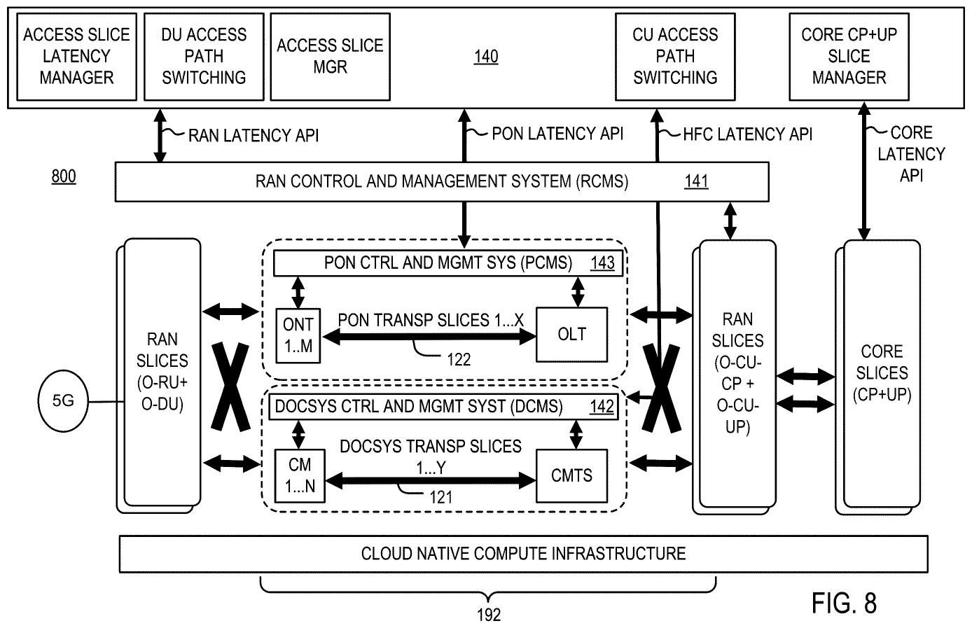

FIG. 8 is an example diagram illustrating dynamic access slice switching to control using mid-haul transport resources in multiple networks as discussed herein.

In this example, the communication system 800 in FIG. 8 includes the different components as previously discussed. The communication system 800 and corresponding communication management resource 140 controls setup of resources in the network 191 and the network 192 to support requested connectivity via access slice switching.

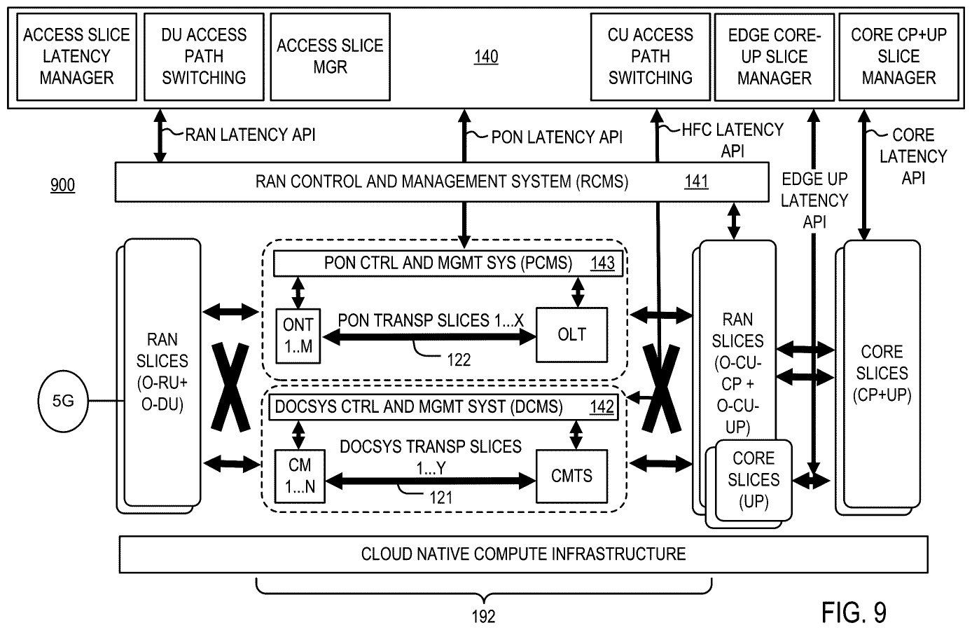

FIG. 9 is an example diagram illustrating dynamic access slice switching in control using mid-haul transport resources as discussed herein.

In this example, the communication system 900 in FIG. 9 includes the different components as previously discussed. The communication system 900 and corresponding communication management resource 140 control resources in the network 191 and the network 192 to support requested connectivity via access slice switching.

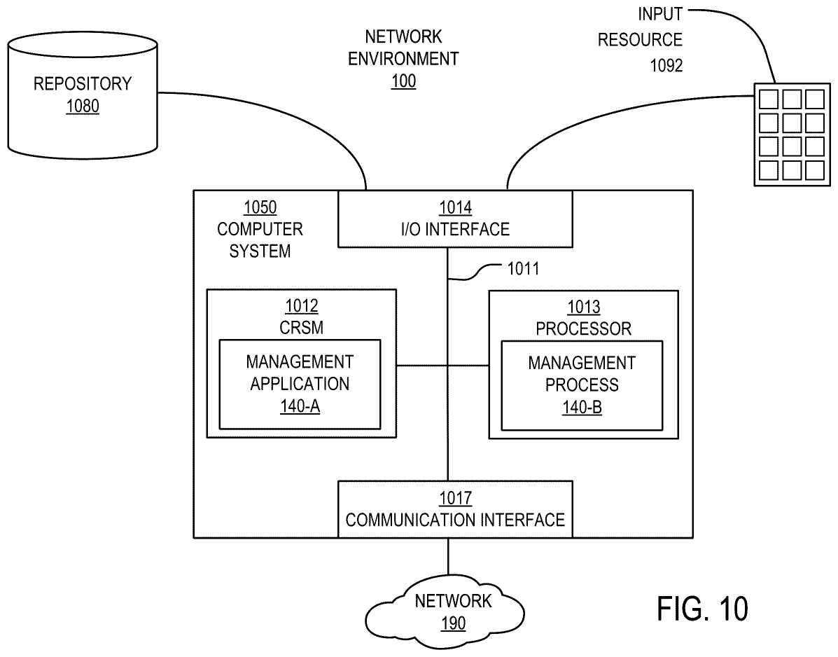

FIG. 10 is an example block diagram of a computer system for implementing any of the operations as previously discussed according to examples herein.

Any of the resources (communication device 101, communication device 102, communication management resource 140, communication management resource 141, communication management resource 142, communication management resource 143, etc.) as discussed herein can be configured to include computer processor hardware and/or corresponding executable instructions to carry out the different operations as discussed herein via computer system 1050.

As shown, computer system 1050 of the present example includes an interconnect 1011 coupling computer readable storage media 1012 such as a non-transitory type of media or, more generally, computer readable hardware which can be any suitable type of hardware storage medium in which digital information can be stored and retrieved, a processor 1013 (computer processor hardware), I/O interface 1014, and a communications interface 1017.

I/O interface(s) 1014 supports connectivity to repository 1080 and input resource 1092.

Computer readable storage medium 1012 (such as computer readable hardware or other suitable entity) can be a hardware storage device or resource such as memory, optical storage, hard drive, floppy disk, etc. In one example, the computer readable storage medium 1012 stores instructions and/or data. Computer readable storage medium 1012 can be a non-transitory storage medium or include non-transitory storage hardware.

As shown, computer readable storage media 1012 can be encoded with communication management application 140-A (e.g., including instructions) to carry out any of the operations as discussed herein.

During operation of one example, processor 1013 accesses computer readable storage media 1012 via the use of interconnect 1011 in order to launch, run, execute, interpret or otherwise perform the instructions in management application 140-A stored on computer readable storage medium 1012. Execution of the management application 140-A produces the management process 140-B to carry out any of the operations and/or processes as discussed herein.

Those skilled in the art will understand that the computer system 1050 can include other processes and/or software and hardware components, such as an operating system that controls allocation and use of hardware resources to execute the management application 140-A.

In accordance with different examples, note that computer system may reside in any of various types of devices, including, but not limited to, a mobile computer, a personal computer system, wireless station, connection management resource, a wireless device, a wireless access point, a access point, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1050 may reside at any location or can be included in any suitable resource in any network environment to implement functionality as discussed herein. In one example, the control system 1050 can include or be implemented in virtualization environments such as the cloud.

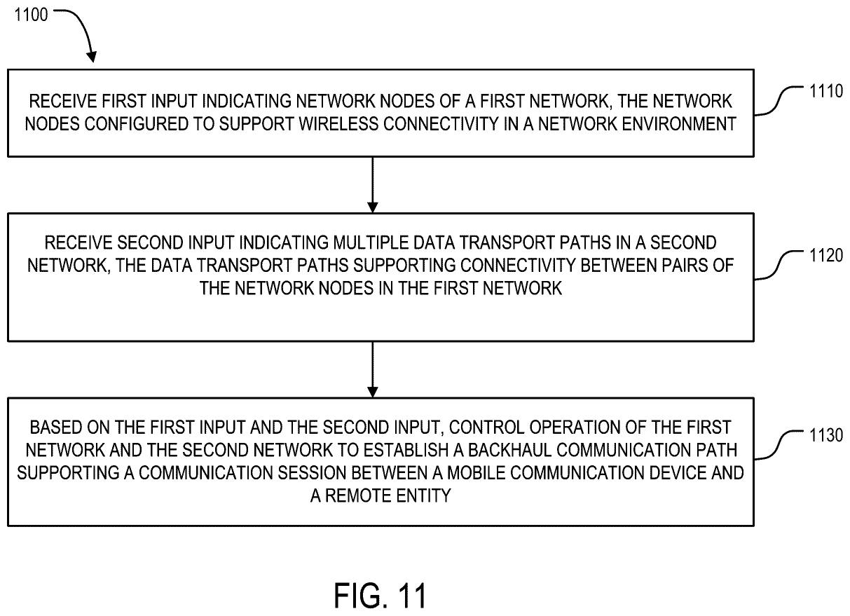

Functionality supported by the different resources will now be discussed via flowchart in FIG. 11. Note that the steps in the flowcharts below can be executed in any suitable order.

FIG. 11 is a flowchart 1100 illustrating an example method according to examples. Note that flowchart 1100 overlaps/captures general concepts as discussed herein.

In processing operation 1110, the communication management resource 140 receives first input such as availability of network nodes in a first network and corresponding performance (such as quality of service) supported by those network nodes in the first network. The first network nodes are configured to support wireless connectivity in a network environment.

In processing operation 1120, the communication management resource receives second input indicating availability of multiple data transport paths in a second network and corresponding performance (such as quality of service) supported by those multiple data transport paths. The data transport paths support connectivity between pairs of the network nodes in the first network.

In processing operation 1130, based on the first input and the second input, the communication management resource controls operation of the first network and the second network to establish a communication path supporting a communication session between a mobile communication device and a remote entity. Establishment of the communication path to the combination of the first network and the second network may include the communication management resource selecting a combination of first resources (such as pairing of network nodes in the first network) and second resources (such as one or more data transport paths in the second network). Subsequent to the selection of the first resources and the second resources, the communication management resource communicates with the first network and the second network to establish the communication path.

Note again that techniques herein are well suited to facilitate more efficient use of available network resources to convey communications through a network between communication devices. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. A method comprising:
receiving first input indicating network nodes of a first network;
receiving second input indicating multiple data transport paths in a second network, the data transport paths supporting connectivity between pairs of the network nodes in the first network; and
based on the first input and the second input, controlling operation of the first network and the second network to establish a communication path supporting a communication session between a mobile communication device and a remote entity.

2. The method as in claim 1, wherein the second network supports multiple data transport paths includes a first data transport path and a second data transport path; and
wherein controlling operation of the first network and the second network includes, in order to support a quality of service assigned to the mobile communication device: i) selecting the first data transport path of the multiple data transport paths, ii) selecting a first pair of network nodes from the network nodes in the first network, and iii) establishing the communication path to include the first data transport path and the first pair of network nodes in the first network.

3. The method as in claim 2, wherein the selected first pair of network nodes includes a first network node and a second network node; and
wherein establishing the communication path includes establishing series connectivity including the first data transport path disposed between the first network node and the second network node.

4. The method as in claim 3, wherein the first network node is a distributed unit (DU) node of the first network; and
wherein the second network node is a central unit (CU) node of the first network.

5. The method as in claim 1, wherein controlling operation of the first network and the second network further includes:
producing control information controlling conveyance of communications over the communication path through the second network; and
communicating the control information to the second network.

6. The method as in claim 5, wherein the second network is operative to execute the control information to provide a quality of service assigned to the mobile communication device.

7. The method as in claim 1, wherein the first network is operated by a first network service provider; and
wherein the second network is operated by a second network service provider independent of the first service provider.

8. The method as in claim 1, wherein the multiple data transport paths in the second network include a first data transport path and a second data transport path; and
wherein controlling operation of the first network and the second network includes, to support a quality of service assigned to the mobile communication device: i) selecting the first data transport path of the multiple data transport paths, ii) selecting a first pair of network nodes from the network nodes in the first network, iii) establishing the communication path to include the first data transport path and the first pair of network nodes in the first network, and iv) in response to detecting degradation of the first data transport path, implementing the second data transport path as a substitute for the first data transport path to support the communication path.

9. The method as in claim 1, wherein controlling operation of the first network and the second network includes:
selecting a first pair of network nodes from first network, the first pair of network nodes including a first network node and a second network node;
selecting a first data transport path from the multiple data transport paths in the second network; and
establishing the communication path to include the first data transport path extending between the first network node and the second network node, the communication session supporting conveyance of communications encoded in accordance with a wireless communication protocol.

10. The method as in claim 9, wherein the first network node is configured to support first network layer processing of a network layer stack; and
wherein the second network node is configured to support second network layer processing of the network layer stack.

11. A system comprising:
communication management hardware operative to:
receive first input indicating network nodes of a first network;
receive second input indicating multiple data transport paths in a second network, the data transport paths supporting connectivity between pairs of the network nodes in the first network; and
based on the first input and the second input, control operation of the first network and the second network to establish a communication path supporting a communication session between a mobile communication device and a remote entity.

12. The system as in claim 11, wherein the second network supports multiple data transport paths includes a first data transport path and a second data transport path; and
wherein the communication management hardware is further operative to: in order to support a quality of service assigned to the mobile communication device: i) select the first data transport path of the multiple data transport paths, ii) select a first pair of network nodes from the network nodes in the first network, and iii) establish the communication path to include the first data transport path and the first pair of network nodes in the first network.

13. The system as in claim 12, wherein the selected first pair of network nodes includes a first network node and a second network node; and
wherein the communication management hardware is further operative to: establish series connectivity including the first data transport path disposed between the first network node and the second network node.

14. The system as in claim 13, wherein the first network node is a distributed unit (DU) node of the first network; and
wherein the second network node is a central unit (CU) node of the first network.

15. The system as in claim 11, wherein the communication management hardware is further operative to:
produce control information controlling conveyance of communications over the communication path through the second network; and
communicate the control information to the second network.

16. The system as in claim 15, wherein the second network is operative to execute the control information to provide a quality of service assigned to the mobile communication device.

17. The system as in claim 11, wherein the first network is operated by a first network service provider; and
wherein the second network is operated by a second network service provider independent of the first service provider.

18. The system as in claim 11, wherein the multiple data transport paths in the second network include a first data transport path and a second data transport path; and
wherein the communication management hardware is further operative to, in order to support a quality of service assigned to the mobile communication device: i) select the first data transport path of the multiple data transport paths, ii) select a first pair of network nodes from the network nodes in the first network, iii) establish the communication path to include the first data transport path and the first pair of network nodes in the first network, and iv) in response to detecting degradation of the first data transport path, implement the second data transport path as a substitute for the first data transport path to support the communication path.

19. The system as in claim 11, wherein the communication management hardware is further operative to:
select a first pair of network nodes from first network, the first pair of network nodes including a first network node and a second network node;
select a first data transport path from the multiple data transport paths in the second network; and
establish the communication path to include the first data transport path extending between the first network node and the second network node, the communication session supporting conveyance of communications encoded in accordance with a wireless communication protocol.

20. The system as in claim 19, wherein the first network node is configured to support first network layer processing of a network layer stack; and
wherein the second network node is configured to support second network layer processing of the network layer stack.

21. Computer-readable storage hardware having instructions stored thereon, the instructions, when carried out by computer processor hardware, cause the computer processor hardware to:
receive first input indicating network nodes of a first network;
receive second input indicating multiple data transport paths in a second network, the data transport paths supporting connectivity between pairs of the network nodes in the first network; and
based on the first input and the second input, control operation of the first network and the second network to establish a communication path supporting a communication session between a mobile communication device and a remote entity.
